(19) United States
(12) Patent Application Publication
(10) Pub. No.: US 2019/0223602 A1
(43) Pub. Date: Jul. 25, 2019

(54) HEADREST MOUNTABLE NECK REST ASSEMBLY

(71) Applicant: Timothy A. Radke, Kenyon, MN (US)

(72) Inventor: Timothy A. Radke, Kenyon, MN (US)

(21) Appl. No.: 15/877,897

(22) Filed: Jan. 23, 2018

(51) Int. Cl. A47C 7/38; A47G 9/10; B60N 2/882; B60N 2/891

(52) U.S. Cl. CPC A47C 7/383; B60N 2/891; B60N 2/882; A47G 9/1081

(57) ABSTRACT

A headrest mountable neck rest assembly for securing a neck rest to a headrest includes a neck rest that includes a middle portion, a first outward portion and a second outward portion wherein the middle portion is positioned between the first and second outward portions. A securing member is attached to and extends away from the neck rest. The securing member releasably engages a headrest of a seat. A cushioning member is removably positioned on the securing member and cushions an interaction between a person's head and the securing member.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art including information disclosed under 37 CFR 1.97 and 1.98.

The disclosure and prior art relates to neck rest devices and more particularly pertains to a new neck rest device for securing a neck rest to a headrest.

### BRIEF SUMMARY OF THE INVENTION

An embodiment of the disclosure meets the needs presented above by generally comprising a neck rest that includes a middle portion, a first outward portion and a second outward portion wherein the middle portion is positioned between the first and second outward portions. A securing member is attached to and extends away from the neck rest. The securing member is configured to releasably engage a headrest of a seat. A cushioning member is removably positioned on the securing member and is configured to cushion an interaction between a person's head and the securing member.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top side view of a headrest mountable neck rest assembly according to an embodiment of the disclosure.

FIG. 2 is a side view of an embodiment of the disclosure.

FIG. 3 is a bottom view of an embodiment of the disclosure.

FIG. 4 is a front view of an embodiment of the disclosure.

FIG. 5 is a back view of an embodiment of the disclosure.

FIG. 6 is a top view of an embodiment of the disclosure.

### DETAILED DESCRIPTION OF THE INVENTION

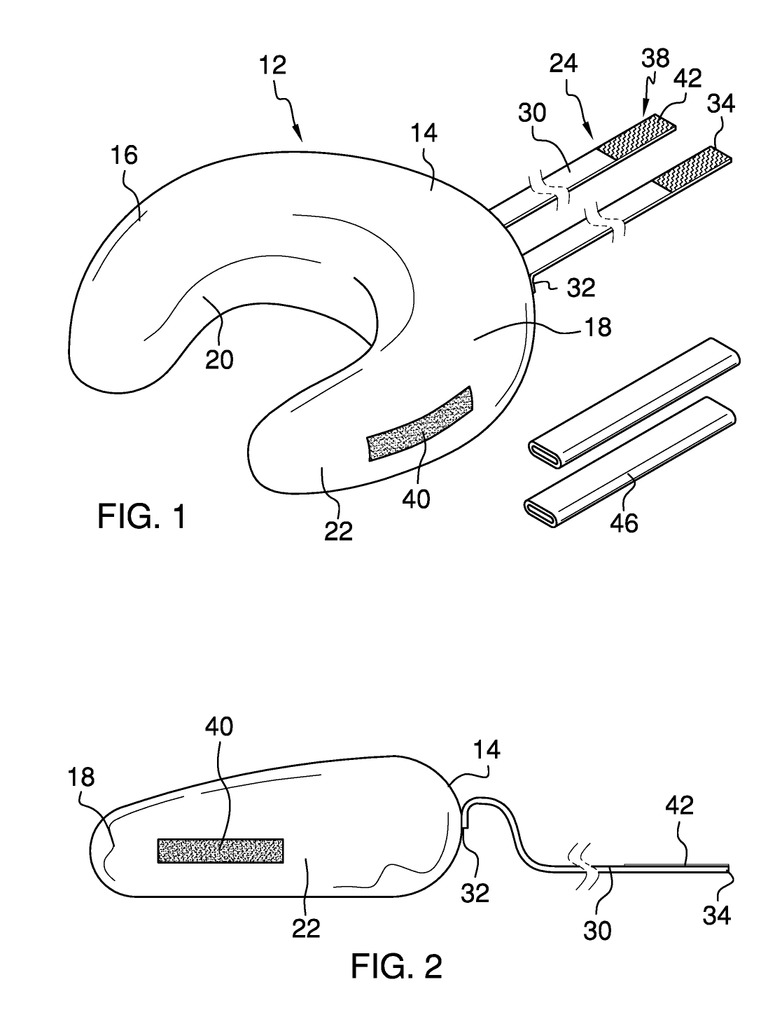

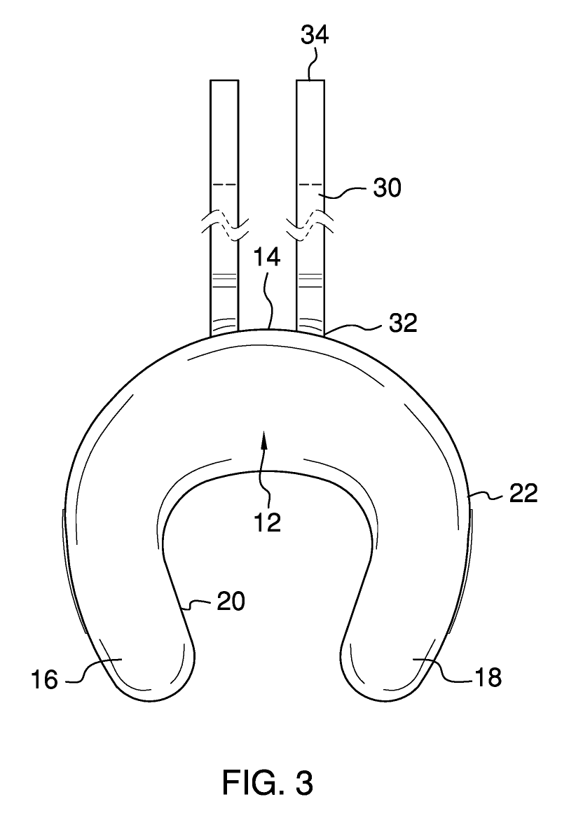

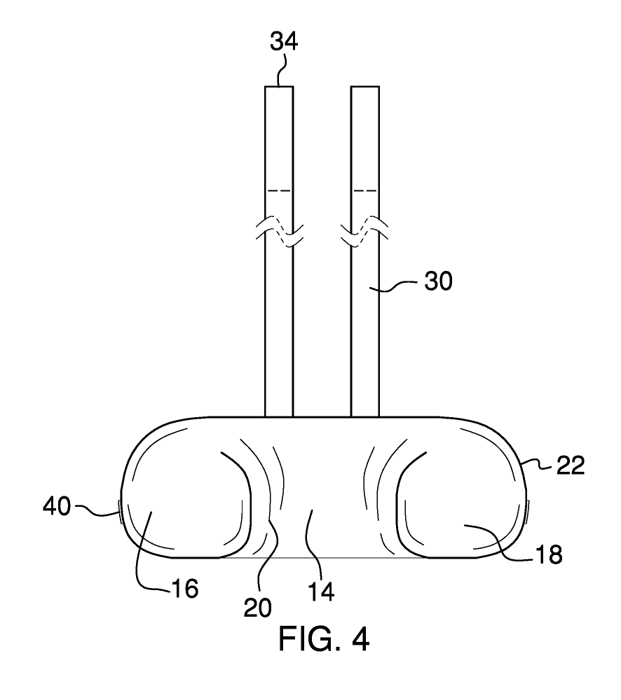

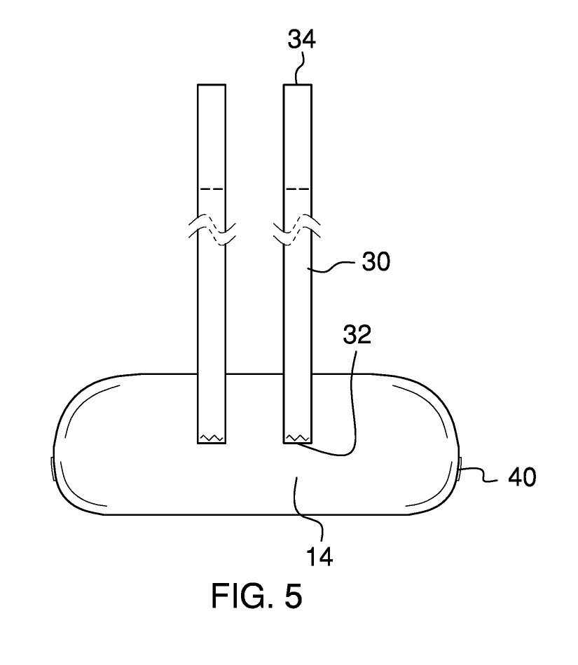

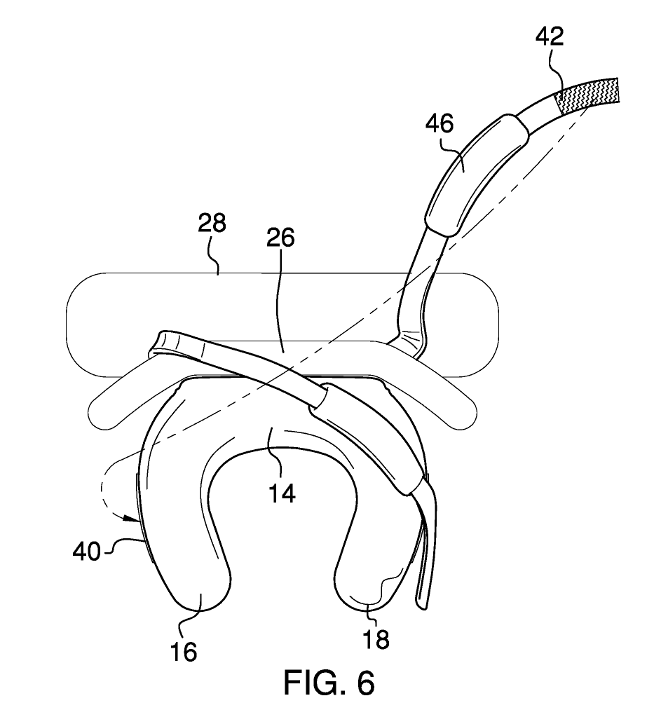

With reference now to the drawings, and in particular to FIGS. 1 through 6 thereof, a new neck rest device embodying the principles and concepts of an embodiment of the disclosure and generally designated by the reference numeral 10 will be described.

As best illustrated in FIGS. 1 through 6, the headrest mountable neck rest assembly 10 generally comprises a neck rest 12 that includes a middle portion 14, a first outward portion 16 and a second outward portion 18 wherein the middle portion 14 is positioned between the first and second outward portions 16, 18. The first outward potion 16 and the second outward portion 18 are spaced apart from each other and have a curved shape such that the neck rest 12 is C-shaped. The neck rest 12 has an inwardly facing surface 20 and an outwardly facing surface 22 wherein the neck rest 12 receives a neck of a person such that the inwardly facing surface 20 abuts the person's neck. The neck rest 12 is resiliently compressible.

A securing member 24 is attached to and extends away from the neck rest 12. The securing member 24 releasably engages a headrest 26 of a seat 28. The securing member 24 includes a strap 30 that has a first end 32 and a second end 34. The strap 30 is elongated from the first end 32 to the second end 34. The first end 32 is attached to the middle portion 14 of the neck rest 12. The second end 34 is releasably attachable to the neck rest 12. The strap 30 is extended around an outer perimeter wall 36 of the headrest 26 and engages the neck rest 12.

A coupler 38 releasably secures the second end 34 to the neck rest 12. The coupler 38 includes a first mating member 40 and a second mating member 42. The first mating member 40 is positioned on the outwardly facing surface 22 of the neck rest 12. The second mating member 42 is positioned on the strap 30 adjacent to the second end 34. The first mating member 40 and the second mating members 42 comprise a hook and loop fastener.

A cushioning member 44 is removably positioned on the securing member 24 and cushions an interaction between a person's head and the securing member 24. The cushioning member 44 comprises a sleeve 46. The strap 30 extends through the sleeve 46. The sleeve 46 is resiliently compressible whereby the person's head is cushioned by the neck rest 12 and the cushioning member 46 when the person's neck is received by the neck rest 12.

In use, the outer surface of the middle portion of the neck rest is held adjacent to the headrest. The strap is pulled under the outer perimeter wall of the headrest and is extended around the outer perimeter wall over the top of the headrest to engage the neck rest. Moreover, the first mating member on the neck rest is secured to the second mating member on the strap to removably mount the neck rest to the headrest.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A neck supporting pillow configured to be releasably attached to a head rest, said neck supporting pillow comprising:
a neck rest including a middle portion, a first outward portion and a second outward portion wherein said middle portion is positioned between said first and second outward portions;
a securing member being attached to and extending away from said neck rest, said securing member being configured to releasably engage a headrest of a seat; and
a cushioning member being removably positioned on said securing member and being configured to cushion an interaction between a person's head and said securing member.

2. The neck supporting pillow according to claim 1, wherein said first outward potion and said second outward portion are spaced apart from each other and have a curved shape such that said neck rest is C-shaped.

3. The neck supporting pillow according to claim 2, wherein said neck rest has an inwardly facing surface and an outwardly facing surface, said neck rest being configured to receive a neck of a person such that said inwardly facing surface abuts the person's neck.

4. The neck supporting pillow according to claim 3, wherein said neck rest is resiliently compressible.

5. The neck supporting pillow according to claim 4, wherein said securing member includes a strap having a first end and a second end, said strap being elongated from said first end to said second end.

6. The neck supporting pillow according to claim 5, wherein said first end is attached to said middle portion, said second end being releasably attached to said neck rest, said strap being configured to be extended around an outer perimeter wall of the headrest and engage said neck rest.

7. The neck supporting pillow according to claim 6, wherein said securing member further includes a coupler releasably securing said second end to said neck rest,

8. The neck supporting pillow according to claim 7, wherein said coupler includes a first mating member and a second mating member, said first mating member being positioned on said outwardly facing surface of said neck rest, said second mating member being positioned on said strap adjacent to said second end.

9. The neck supporting pillow according to claim 8, wherein said first mating member and said second mating members comprise a hook and loop fastener.

10. The neck supporting pillow according to claim 9, wherein said cushioning member comprises a sleeve, said strap extending through said sleeve, said sleeve being resiliently compressible.

11. A neck supporting pillow configured to be releasably attached to a head rest, said neck supporting pillow comprising:
a neck rest including a middle portion, a first outward portion and a second outward portion wherein said middle portion is positioned between said first and second outward portions, said first outward potion and said second outward portion being spaced apart from each other and having a curved shape such that said neck rest is C-shaped, said neck rest having an inwardly facing surface and an outwardly facing surface, said neck rest being configured to receive a neck of a person such that said inwardly facing surface abuts the person's neck, said neck rest being resiliently compressible;
a securing member being attached to and extending away from said neck rest, said securing member being configured to releasably engage a headrest of a seat, said securing member including a strap having a first end and a second end, said strap being elongated from said first end to said second end, said first end being attached to said middle portion, said second end being releasably attached to said neck rest, said strap being configured to be extended around an outer perimeter wall of the headrest and engage said neck rest, a coupler releasably securing said second end to said neck rest, said coupler including a first mating member and a second mating member, said first mating member being positioned on said outwardly facing surface of said neck rest, said second mating member being positioned on said strap adjacent to said second end, said first mating member and said second mating members comprising a hook and loop fastener; and
a cushioning member being removably positioned on said securing member and being configured to cushion an interaction between a person's head and said securing member, said cushioning member comprising a sleeve, said strap extending through said sleeve, said sleeve being resiliently compressible.
